(19) United States
(12) Patent Application Publication
(10) Pub. No.: US 2009/0003969 A1
(43) Pub. Date: Jan. 1, 2009

(54) LINEAR ADJUSTMENT ASSEMBLY

(76) Inventors: MICHAEL T. GATTONE, Tinley Park, IL (US); DARIEN P. HOBBS, La Vergne, TN (US)

Correspondence Address: ILLINOIS TOOL WORKS INC., 3600 WEST LAKE AVENUE, PATENT DEPARTMENT, GLENVIEW, IL, 60025, US

(21) Appl. No.: 12/146,795

(22) Filed: Jun. 26, 2008

Related U.S. Application Data
(60) Provisional application No. 60/937,769, filed on Jun. 29, 2007.

(51) Int. Cl. F16B 33/02

(52) U.S. Cl. 411/413; 411/411

(57) ABSTRACT

An adjusting device for repositioning a movable component relative to a stationary component includes a shank having a head at one end thereof and a distal tip at an opposite end thereof. The adjusting device also includes a first thread formed on the shank, the first thread disposed in a helical pattern along the shank, and a reversing thread formed on the shank, the reversing thread disposed in a helical pattern along the axial surface of the shank, the reversing thread helical pattern is formed in a direction that is opposite to the helical pattern of the first thread. Also described herein is a linear adjustment assembly that includes an adjusting device and a retaining device. The retaining device includes a thread disposed in a helical pattern along an interior surface of the retaining device having a helical pattern that is substantially similar to the first thread helical pattern.

### CROSS REFERENCE TO RELATED APPLICATION

This Non-Provisional Application claims benefit to U.S. Provisional Application Ser. No. 60/937,769 filed on Jun. 29, 2007, the complete subject matter of which is expressly incorporated herein in its entirety.

### BACKGROUND OF THE INVENTION

The present invention relates generally to threaded adjustment assemblies, and more particularly to linear adjustment assemblies, such as those commonly used as vehicle headlamp or fog lamp adjusters. One known adjustment assembly includes a threaded fastener that is used as an adjusting element, a spring, and a nut that is threaded to receive the fastener. The known adjustment assembly also includes a metallic spiral wound spring that is disposed around the shaft of the fastener and between the component being adjusted and a fixed component.

During operation, the spring retains the head of the fastener against the component being adjusted so as to hold the fastener securely in an opening or hole that is formed in the component. The spring also provides some amount of prevailing torque that causes the fastener to be able to withstand outside influences, such as vibration, without self adjusting and changing the position of the component being adjusted.

To adjust the component, the fastener is rotated in a first direction to move the component in a first direction or rotated in a second direction to move the component in a second direction. However, when the threaded fastener reaches the end of its designed travel, the end user may inadvertently continue to apply torque to the threaded fastener. Applying torque to the threaded fastener at the end of its designed travel may cause the fastener to deform, strip the fastener threads, or eventually break the fastener or associated components. As a result, the entire adjustment assembly may require replacement.

Another drawback associated with known adjustment assemblies is that they are typically fabricated using metallic material that is prone to corrosion. To reduce corrosion, conventional adjustment assemblies may be coated with a corrosion resistant material to increase the operational life of the adjustment assembly. However, fabricating adjustment assemblies using a metallic material that may experience corrosion and coating the adjustment assemblies with a corrosion resistant material increases the cost of manufacturing the adjustment assemblies.

A need remains for an adjustment assembly that is economical to manufacture, that includes a prevailing torque or vibration resistance feature, that is able to prevent an over-torque condition from occurring and thus prevent the threaded fastener from being damaged during operation, and that is also fabricated from a material that resists corrosion or a non-metallic material to prevent corrosion.

### SUMMARY OF THE INVENTION

In one embodiment, an adjusting device for repositioning a movable component relative to a stationary component is provided. The adjusting device includes a shank having a head at one end thereof and a distal tip at an opposite end thereof and a first thread formed on the shank, the first thread disposed in a helical pattern along the shank. The adjusting device also includes a reversing thread formed on the shank, the reversing thread disposed in a helical pattern along the axial surface of the shank, the reversing thread helical pattern is formed in a direction that is opposite to the helical pattern of the first thread. The reversing thread is configured to enable a free spinning connection between the threaded fastener and a retaining device when the threaded fastener is rotated in a first direction, and to enable threaded movement between the threaded fastener and the retaining device when the threaded fastener is rotated in an opposite second direction.

In one embodiment, the components of the adjusting device are made out of a suitable plastic material.

In another embodiment, at least one of the threaded fastener and the retaining device include a prevailing torque or vibration resistance feature. According to one embodiment, the threaded fastener includes a wavy thread form. According to another embodiment, the retaining device is a nut with an asymmetrical thread form and/or interference protrusions or depressions to interfere with the mating male thread form.

Other features and advantages of the invention will become apparent to those skilled in the art upon review of the following detailed description, claims and drawings in which like numerals are used to designate like features. For example, according to various embodiments of the invention, the threaded fastener can be configured to accommodate different sized panels. BRIEF DESCRIPTION OF THE DRAWINGS

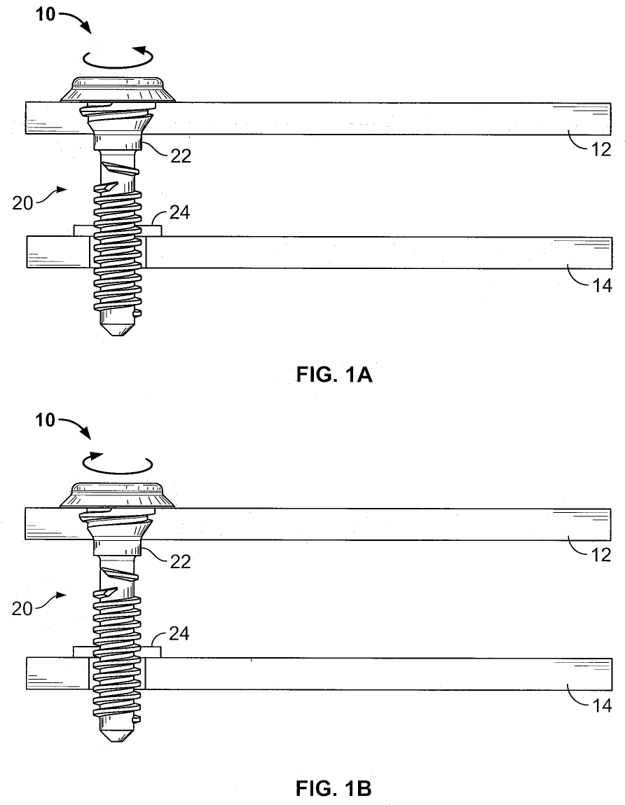

FIGS. 1A and 1B are side views of an exemplary assembly that includes at least one exemplary adjustment assembly in accordance with an embodiment of the present invention.

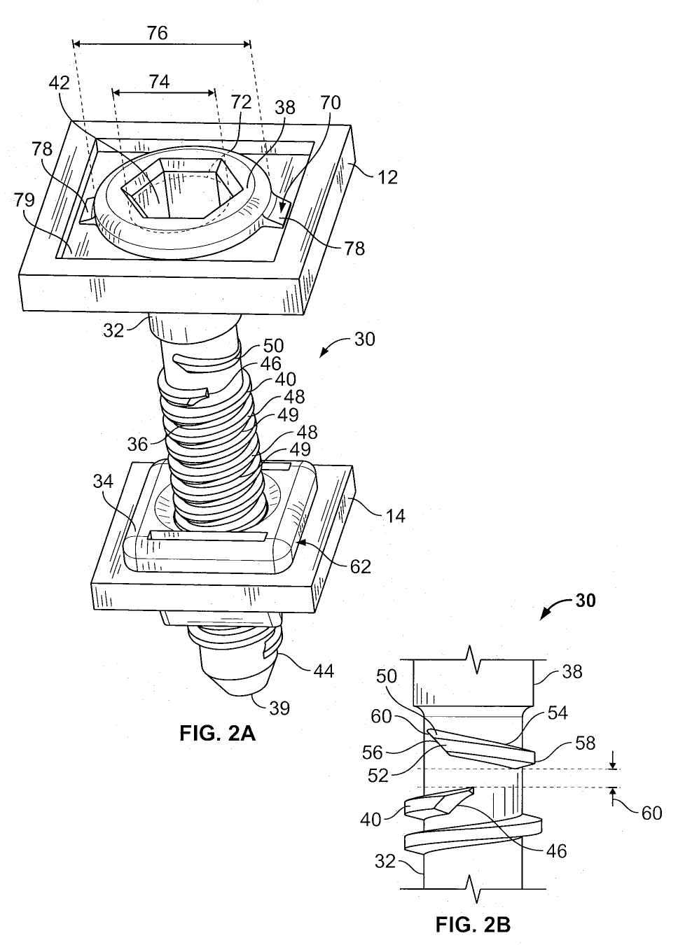

FIGS. 2A and 2B are side views of another exemplary adjustment assembly in accordance with an embodiment of the present invention.

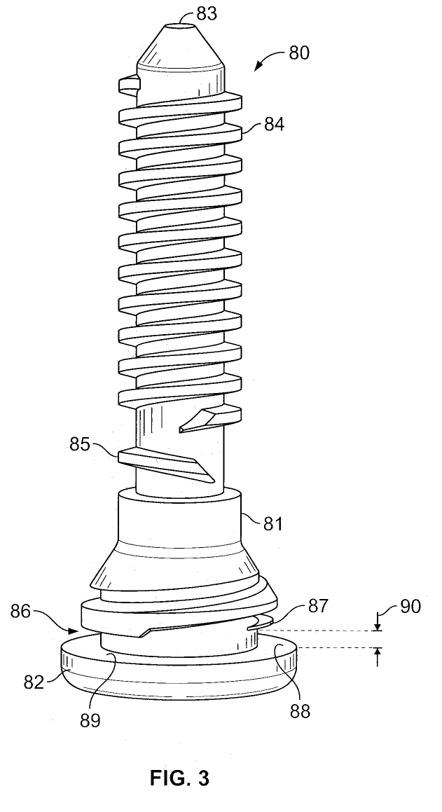

FIG. 3 is a side view of a threaded fastener according to the present invention.

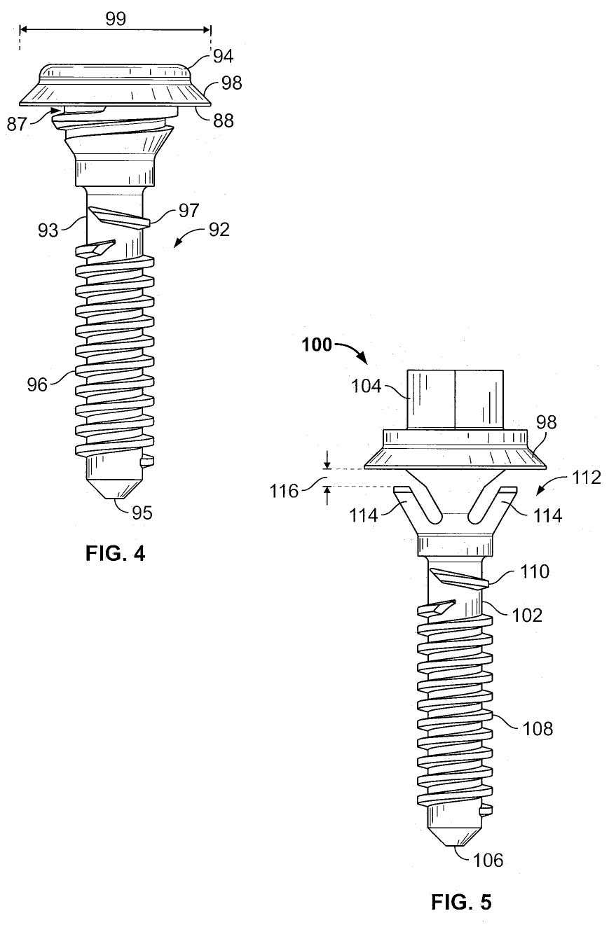

FIG. 4 is a side view of another threaded fastener according to the present invention.

FIG. 5 is a side view of yet another threaded fastener according to the present invention.

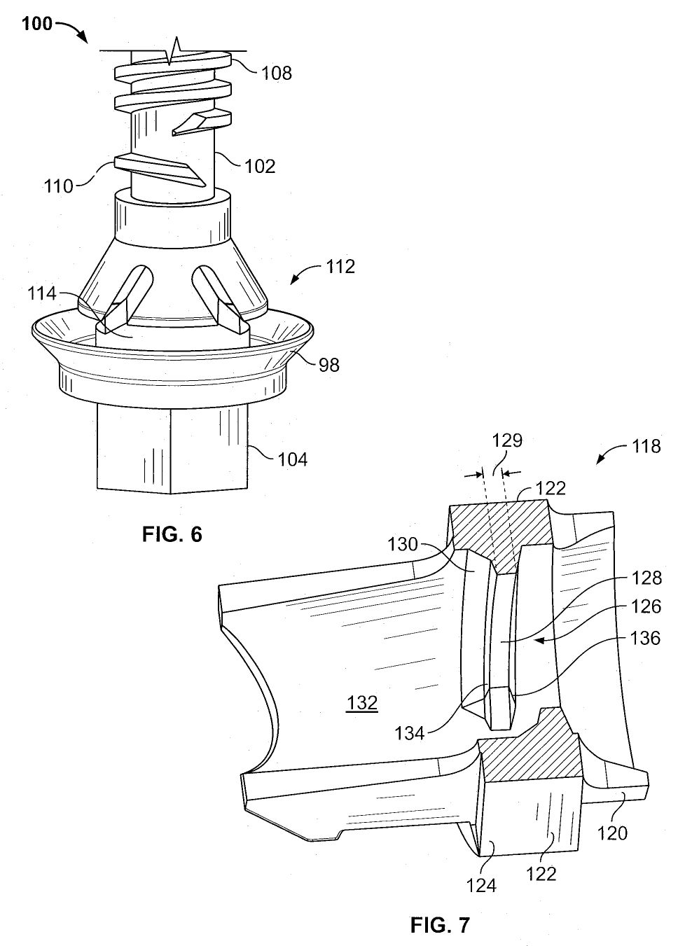

FIG. 6 is an enlarged view of a portion of the threaded fastener shown in FIG. 5.

FIG. 7 is a cross-section of an exemplary retaining device for use with the threaded fasteners shown in FIGS. 2-5 in accordance with the present invention.

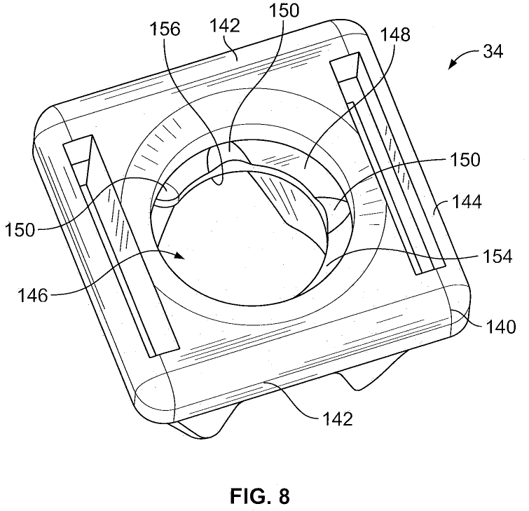

FIG. 8 is a top perspective view of another exemplary retaining device according to the present invention.

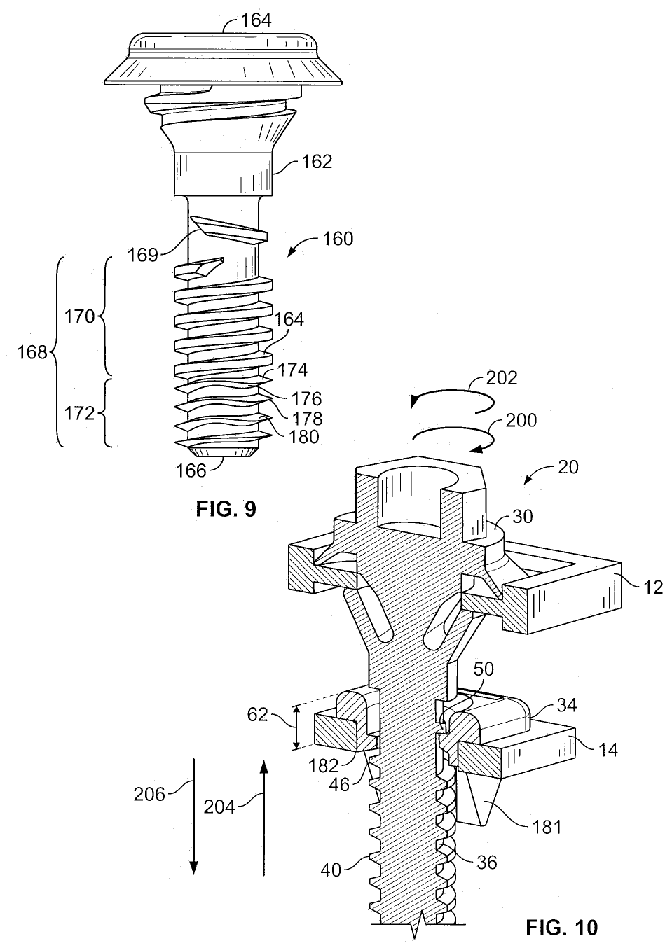

FIG. 9 is a side view of another threaded fastener in accordance with an embodiment of the present invention.

FIG. 10 is a cross-section of an adjustment assembly in accordance with an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

FIG. 1A illustrates an exemplary assembly 10 in a first operational position. FIG. 1B illustrates an exemplary assembly 10 in a second operational position. The assembly can be any number of different assemblies, but for illustrative purposes, can be thought of as a vehicle headlamp or fog lamp adjuster device. The assembly 10 includes at least one exemplary linear adjustment assembly 20 in accordance with an embodiment of the present invention. Although the invention is described in connection with a vehicle light adjuster assembly, the embodiments of the adjustment assembly described herein are capable of use in other applications, and a vehicle light adjuster assembly 10 is noted as an example of one such application.

Assembly 10 includes a first component 12 and a second component 14. The exemplary adjustment assembly 20 is connected to both the first component 12 and the second component 14. Generally speaking, one of the components 12 and 14 is fixed relative to the adjustment assembly 20 and the other of the components 12 and 14 is adjustably located with respect to the adjustment assembly 20. In one example, second component 14 may include a vehicle light (not shown) and first component 12 may be a fixed bracket relative to the associated vehicle (not shown). The adjustment assembly 20 is configured to reposition the second component 14 with respect to the first component 12. As shown, the adjustment assembly 20 includes an adjusting device such as fastener device 22, for example, and a retaining device 24 that is configured to couple to the fastener device 22. In the exemplary embodiment, the fastener device 22 is a threaded fastener such as a bolt or threaded screw, and the retaining device 24 is a nut that is configured to couple to the bolt or screw.

As shown in FIGS. 1A and 1B, during operation when the fastener device 22 is rotated in a particular direction, the component 14, e.g. the movable component, is moved axially away from the component 12, e.g. the stationary component. When the fastener device 22 is rotated in the opposite direction, the component 14 is moved axially towards or nearer to the component 12. Reference is made to FIGS. 1A and 1B where component 14 is shown in different locations along threaded fastener 22. It should be understood that there are numerous operational positions of the component 14 between fully retracted and fully extended which are attainable depending upon the amount of rotation imparted to the fastener device 22. The adjustment assembly 20 is operable to reposition a movable component, e.g., a reflector or light, linearly with respect to a stationary component, e.g., a component 12, and thus reposition the light or reflector with respect to the vehicle chassis.

The fastener device 22 and the retaining device 24 are each fabricated using a corrosion resistant or corrosion proof material. In the exemplary embodiment, the fastener device 22 and the retaining device 24 and all the components included in each, are fabricated using a plastic material. Optionally, the fastener device 22 and the retaining device 24 may be fabricated using a corrosion resistant material, such as for example, aluminum or stainless steel.

FIG. 2A is a perspective view of another exemplary adjustment assembly 30 in accordance with an embodiment of the present invention. FIG. 2B is an enlarged view of a portion of the adjustment assembly shown in FIG. 2A. As shown in FIG. 2A, the adjustment assembly 30 includes a fastener device 32 and a retaining device 34. The retaining device 34 is discussed in more detail below. The fastener device 32 includes a shank 36 having a head 38 at one end thereof and a distal tip or end 39 at an opposite end thereof. In the exemplary embodiment, the head 38 has an opening 42 formed therein to receive a wrench. Optionally, the head 38 may have a slot formed therein to receive a screwdriver. Those skilled in the art will understand that the head 38 may be otherwise configured with a cavity for receiving a Phillips screwdriver, a torx driver, a hexagonal wrench or the like. Moreover, the outer peripheral shape of the head 38 may be configured for engagement by a wrench or socket.

In the exemplary embodiment, the fastener head 38 is coupled to the component 12 and the retaining device 34 is coupled to the component 14. It should be realized that the embodiment illustrated in FIG. 2A is exemplary and that the adjustment assembly 30 may be coupled to the assembly 10 in other configurations. For example, in another embodiment, the fastener head 38 can be coupled to the component 14 and the retaining device 34 can be coupled to the component 12.

The fastener device 32 includes a first thread 40 that is disposed in a helical pattern along an exterior surface of the shank 36. In the exemplary embodiment, the fastener device 32 is a molded plastic component. The first thread 40 can be formed by removing or machining material (not shown) from the shank 36. Optionally, the first thread 40 may be formed during the casting process of the fastener device 32. The first thread 40 includes a distal end 44 that is located proximate to the distal tip 39 and extends along the length of the shank 36 at least partially towards the head 38. The first thread 40 also includes a proximal end 46. It should be realized that the distal end 44 of the first thread 40 is disposed sufficiently near the distal tip 39 to enable the retaining device 34 to threadably engage the first thread 40.

In one exemplary embodiment, the first thread 40 follows a straight line helical path within the helical pattern. More specifically, the first thread 40 is formed having a single helical pitch. For example, the first thread 40 includes a plurality of thread crests 48 and a plurality of thread roots 49, wherein the nominal distance between at least two adjacent thread crests 48 or two adjacent thread roots 49 is substantially the same. In another exemplary embodiment, the first thread 40 does not follow a straight line helical path as is discussed below.

The fastener device 32 also includes a second or reversing thread 50 that is disposed between the first thread 40 and the head 38. In the exemplary embodiment, the reversing thread 50 has a helical pitch that is different than the first thread 40 helical pitch. As shown in FIG. 2B, the reversing thread 50 is a partial thread that extends less than 360 degrees circumferentially around the surface of shank 36. The reversing thread 50 includes only a single thread crest 52 and a single thread root 54. The reversing thread 50 also includes a proximal end 56 and a distal end 58. The reversing thread proximal end 56 is disposed proximate to the head 38 and the distal end 58 is disposed between the proximal end 56 and the proximal end 46 of the first thread 40. The reversing thread distal end 58 is separated by the first thread proximal end 46 by a predetermined longitudinal distance or gap 60. In one embodiment, the predetermined distance 60 is less than a thickness of a single thread formed in a retaining device, e.g. retaining device 34 that is coupled to the fastener device 32. Optionally, the predetermined distance 60 is less than a thickness of a retaining device, e.g. retaining device 34 that is coupled to the fastener device 32.

In the exemplary embodiment, the reversing thread 50 helical pattern is formed in a direction that is different to the helical pattern of the first thread 40. For example, the helical pattern of the first thread 40 may be configured as “right hand” threads and the helical pattern of the reversing thread 50 may be configured as a “left hand” thread. Optionally, the helical pattern of the first thread 40 may be configured as “left hand” threads and the helical pattern of the reversing thread 50 may be configured as a “right hand” thread.

During operation, the reversing thread 50 enables the fastener device 32 to continuously rotate or freewheel when the retaining device 34 has reached the proximal end 46 of the first thread 40. More specifically, when the fastener device 32 is threaded into the retaining device 34, once the retaining device 34 runs out of thread, e.g. the retaining device 34 reaches the proximal end 46 of the first thread 40 the fastener device 32 freely rotates around the retaining device 34 thus eliminating the possibility of an over-torque condition from occurring. In the exemplary embodiment, the retaining device 34 includes a single thread that is discussed in more detail below. The single thread rotates between the proximal end 46 of the first thread 40 and the distal end 58 of the reversing thread 50. However, when the when the fastener device 32 is rotated in an opposite direction, the reversing thread 50 directs the retaining device 34 to re-engage the first thread 40.

In the exemplary embodiment, the fastener device 32 also includes a latch mechanism 70 that is configured to enable the fastener device 32 to be coupled to, or captured by component 12 or 14 as the case may be. During operation, the latch mechanism 70 is configured to absorb the manufacturing tolerances of the thickness for component 12 and the width of an opening 72, shown in FIG. 2A that is configured to receive the head 38 therethrough. Additionally, the latch mechanism 70 is configured to reduce or substantially eliminate residual axial movement between the head 38 and the component 12 while still allowing the head 38 to freely rotate within the opening 72.

More specifically, the component 12 includes the opening 72 extending there through that is sized to receive head 38. The opening 72 has a diameter 74 that is less than a diameter 76 of the head 38. During assembly, fastener device 32 is inserted into the opening 72 until the latch mechanism 70 to snaps into the component 12. In the exemplary embodiment, the latch mechanism 70 is configured to deform when a predetermined amount of pressure is applied to the latch mechanism 70. The predetermined pressure is generally sufficient to couple the fastener device 32 to the component 12. In the exemplary embodiment, the latch mechanism is formed unitarily with the fastener device 32.

The latch mechanism 70 includes at least two latches 78 as shown in FIG. 2A. In the exemplary embodiment, the latches 78 are formed with the head 38 and are spaced equidistantly around a periphery of the head 38. The width and thickness of the latches 78 is selected such that a predetermined amount of pressure is applied by the latches 78 to the component 12 to enable the fastener device 32 to be coupled to the component 12 as discussed above. In the exemplary embodiment, the latches 78 are linear flex-springs of the cantilever type that extends radially outward from the head 38. Moreover, the latches 78 are disposed approximately parallel to a surface 79 of the component 12. As shown in FIG. 2A, the latches 78 extend radially outwardly from the head 38 and have a length that is sufficient to capture the head 38 in the opening 72. During operation, the latches 78 distribute the load applied by the fastener device 32 onto the component 12 to allow the fastener device 32 to move a designed amount to compensate for vibration or other movement. Additionally, the latches 78 maintain a prevailing torque on the fastener device 32. As such, the latches are flexible to compensate for expansion and contractor of the adjustment assembly 30 while still maintaining the predetermined torque on the fastener device 32 under variable operating conditions. The latches 78 also distribute the retention load of the fastener device 32 over an increased surface area of the component 12 thereby reducing any concentration of retention or coupling forces applied to the component 12.

FIG. 3 illustrates another exemplary fastener device 80 that may be used with the assembly 10 shown in FIG. 1. The fastener device 80 includes a shank 81 having a head 82 at one end thereof and a distal tip or end 83 at an opposite end thereof. The fastener device 80 also includes a first thread 84 and a reversing thread 85. In the exemplary embodiment, the first thread 84 is substantially similar to the first thread 40 and the reversing thread 85 is substantially similar to the reversing thread 50, each shown in FIG. 2. In the exemplary embodiment, the fastener device 80 also includes an exemplary latching mechanism 86. It should be realized that the latching mechanism 86 may be used with the fastener device 32 shown in FIG. 2 in lieu of latching mechanism 70. The latching mechanism 86 includes a retaining thread 87 that terminates in a flat plane 88 that is formed on a surface 89 of the fastener head 82. In the exemplary embodiment, the retaining thread 87 has a helical pitch and extends only partially around the shank 81. In one embodiment, the retaining thread helical pitch may be the same as the helical pitch of either the first thread 84 or the reversing thread 85. Optionally, the retaining thread helical pitch is different than the helical pitch of either the first thread 84 or the reversing thread 85. In the exemplary embodiment, the retaining thread 87 extends less than 360 degrees circumferentially around the surface of the shank 81. As shown in FIG. 3, the retaining thread 87 terminates a predetermined distance 90 from the flat plane 88. In the exemplary embodiment, the predetermined distance 90 is defined based on the thickness of the component 12. For example, assuming that the component 12 has a thickness of ¼ inch, the predetermined distance 90 is equal to or slightly less than ¼ inch to enable the retaining thread 87 to capture the component 12. During assembly, the distal end 83 of fastener device 80 is inserted into the opening 72 in the component 12. The fastener device 80 is positioned until the retaining thread 87 engages the surfaces of the component 12 that define the opening 72. The fastener device 80 is then rotated to enable the retaining thread 87 to engage the component 12. In the exemplary embodiment, the fastener device 80 is rotated less than 360 degrees to engage the component 12. In the assembled position, the retaining thread 87 distributes the load applied by the fastener device 80 onto the component 12 via the flat plane 88.

FIG. 4 is a side view of another exemplary fastener device 92 that may be used with the assembly 10 shown in FIG. 1. The fastener device 92 includes a shank 93 having a head 94 at one end thereof and a distal tip or end 95 at an opposite end thereof. The fastener device 92 also includes a first thread 96 and a reversing thread 97. In the exemplary embodiment, the first thread 96 is substantially similar to the first thread 40 and the reversing thread 97 is substantially similar to the reversing thread 50, each shown in FIG. 2. In the exemplary embodiment, the fastener device 92 also includes an exemplary spring device 98. In the exemplary embodiment, the spring device 98 has a concave shape and extends radially around, and is formed with, the head 94. In one embodiment, the spring device 98 has a diameter 99 that is greater than the diameter 74 of the opening 72 shown in FIG. 2. During operation, the spring device 98 works in combination with the retaining thread 87 and flat plane 88, also shown in FIG. 3, to secure the fastener device 92 to the component 12. Moreover, in the exemplary embodiment, the spring device 98 is fabricated from a flexible plastic material to enable the spring device 98 to deform when sufficient pressure is exerted on the spring device 98. For example, in the exemplary embodiment, since the diameter 99 of the spring device 98 is greater than the diameter of the head 94, the spring device 98 provides some amount of prevailing torque that causes the fastener device 92 to be able to withstand the rigors of vibration on the vehicle without self adjusting and changing the position of the component 12.

FIG. 5 is a side view of another exemplary fastener device 100 that may be used with the assembly 10 shown in FIG. 1. FIG. 6 is a side view of the latch mechanism 112 shown in FIG. 5. The fastener device 100 includes a shank 102 having a head 104 at one end thereof and a distal tip or end 106 at an opposite end thereof. The fastener device 100 also includes a first thread 108 and a reversing thread 110. In the exemplary embodiment, the first thread 108 is substantially similar to the first thread 40 and the reversing thread 110 is substantially similar to the reversing thread 50, each shown in FIG. 2. In the exemplary embodiment, the fastener device 100 also includes the exemplary latch mechanism 112 that may be used with the spring device 98 shown in FIG. 4. Although the latch mechanism 112 is shown as being used in conjunction with the spring device 98, it should be realized that the latch mechanism 112 may be used separately from the spring device 98. In the exemplary embodiment, the latch mechanism 112 includes at least two latches 114. In the exemplary embodiment, the latches 114 are formed unitarily with the head 104 and are spaced equidistantly around a periphery of the head 104. The width and thickness of the latches 114 are selected such that a predetermined amount of pressure is applied by the latches 114 to the component 12 to enable the fastener device 100 to be coupled to the component 12 as discussed above. In the exemplary embodiment, the latches 114 are linear flex-springs of the cantilever type that extends radially outward from the head 104. As shown in FIG. 5, the latches 114 extend radially outwardly from the head 104 and have a length that is sufficient to capture the head 104 in the opening 72. As shown in FIG. 5, the latches 114 are separated from the head 104 by a distance 116 that is approximately equal to the thickness of the component 12. During operation, the latches 114 enable the fastener device 100 to be snapped into the opening 72. More specifically, the latches 114 are configured to deform radially inward to enable the latches 114 to be inserted into the opening 72. After the latches 114 are inserted into the opening 72, the latches 114 are configured to deform radially outward such that the fastener device 100 is retained within the opening 72. The latches 114 also distribute the retention load of the fastener device 100 over an increased surface area of the component 12 thereby reducing any concentration of retention or coupling forces applied to the component 12.

FIG. 7 is a cross-section of an exemplary retaining device 118 that may be used with any of the fastener devices described herein. In the exemplary embodiment, the retaining device 118 is a nut that includes a body 120 having a plurality of outer side surfaces 122. The outer side surfaces 122 form an overall peripheral surface 124 that is generally hexagonal in shape, but can be of any suitable shape. The body 120 also includes a threaded opening 126 for engagement with any of the fastener devices described herein. In the exemplary embodiment, the retaining device 118 has the same thread pitch as the first thread 40, and as such, has a different thread pitch than the reversing thread 50. Optionally, the retaining device 118 includes a plurality of threads 128 that each has the same pitch as the first thread 40 on the fastener device 30 for example. In the exemplary embodiment, the retaining device 118 includes at least one thread 128. As discussed above, in one embodiment, the thread 128 has a thickness 129 that is greater than the distance 60 (shown in FIG. 2B) that is defined between the first thread 40 and the reversing thread 50.

The retaining device 118 also includes a friction ramp 130. In the exemplary embodiment, the friction ramp 130 is formed unitarily with the retaining device 118. The friction ramp 130 has a generally triangular shape and extends from an interior surface 132 of the body 120 to a surface 134 formed on the thread 128. In the exemplary embodiment, the friction ramp 130 is formed on only one side or surface 134 of the thread 128. Optionally, the friction ramp 130 may be formed on an opposite surface 136 of the thread 128. In another embodiment, a friction ramp 130 may be formed on both surfaces 134 and 136 of the thread 128. It should be realized, that although the retaining device 118 is shown as having only one thread 128, that in an optional embodiment, the retaining device 118 may include multiple threads 128. Moreover, it should be realized that a friction ramp 130 may be formed on one side or both sides of multiple threads 128 in the retaining device 118 and that a single thread 128 having a single friction ramp 130 is exemplary.

During operation, the friction ramp(s) 130 interact with the first thread 40 on the fastener device 30 to interfere with the major diameter of the fastener device 30 a controlled amount thereby creating a certain torque due to sliding friction. More specifically, the friction ramp(s) 130 allow for the creation and control of prevailing torque between the fastener device 30 and the retaining device 118. The prevailing torque enabled by the friction ramp(s) 130 also enables the adjustment assembly 10 to compensate for vibration characteristics of the vehicle without self-adjusting and changing the position of the component 12.

FIG. 8 is a top perspective view of the exemplary retaining device 34 (shown in FIG. 2A. In the exemplary embodiment, the retaining device 34 is a nut that includes a body 140 having a plurality of outer side surfaces 142. The outer side surfaces 142 form an overall peripheral surface 144 that is generally square in shape, but can be of any suitable shape. The body 140 also includes a threaded opening 146 for engagement with the fastener device 30. In the exemplary embodiment, the retaining device 34 has the same thread pitch as the first thread 40, and as such, has a different thread pitch than the reversing thread 50. In the exemplary embodiment, the retaining device 34 includes at least one thread 148. Optionally, the retaining device 34 may include a plurality of threads 148 that each has the same pitch as the first thread 40 on the fastener device 30.

The retaining device 34 also includes a plurality of protrusions or bumps 150. In the exemplary embodiment, the protrusions 150 are formed unitarily with the retaining device 34. The protrusions 150 each have a generally circular shape and extend outwardly or away from an exterior surface 154 of the thread 148. In the exemplary embodiment, the protrusions 150 are formed on only one side or surface 154 of the thread 148. Optionally, the protrusions 150 may be formed on an opposite surface 156 of the thread 148. In another embodiment, the protrusions 150 may be formed on both surfaces 154 and 156 of the thread 128. It should be realized, that although the retaining device 34 is shown as having only one thread 148, that in an optional embodiment, the retaining device 34 may include multiple threads 148. Moreover, it should be realized that the protrusions 150 may be formed on one side or both sides of multiple threads 148 in the retaining device 34 and that a single thread 148 having at least one protrusion 150 is exemplary.

During operation, the protrusions 150 interact with the first thread 40 on the fastener device 30 to interfere with the major diameter of the fastener device 30 a controlled amount thereby creating a certain torque due to sliding friction. More specifically, the protrusions 150 allow for the creation and control of prevailing torque between the fastener device 30 and the retaining device 34. The prevailing torque enabled by the protrusions 150 also enable the adjustment assembly 20 to compensate for vibration characteristics of the vehicle without self-adjusting and changing the position of the component 12.

FIG. 9 is a side view of another exemplary fastener device 160 that may be used with the adjustment assembly 20 shown in FIG. 1. The fastener device 160 is substantially similar to the fastener devices shown in FIG. 2-6. The fastener device 160 includes a shank 162 having a head 164 at one end thereof and a distal tip or end 166 at an opposite end thereof. The fastener device 160 also includes a first thread 168 and a reversing thread 169. In the exemplary embodiment, the reversing thread 169 is substantially similar to the reversing thread 50 shown in FIG. 2. The fastener device 160 may also include any of the exemplary latch mechanisms and spring devices described above.

In the exemplary embodiment, the first thread 168 follows a curved-line path disposed on shank 162 in a helical pattern. Reference is made to U.S. Pat. No. 7,326,014 describing a known curved-lined thread. In the exemplary embodiment, the first thread 168 includes a first thread portion 170 that is substantially similar to the first thread 40 described above. The first thread 168 also includes a second thread portion 172 that follows a curved path in the shape of a sinusoidal wave. The second thread portion 172 includes a pressure flank 174, a trailing flank 176, a thread crest 178 and a thread root 180. In the exemplary embodiment, the form of second thread portion 172 remains the same in cross-sectional shape throughout the curved path. Thus, the relationship between pressure flank 174, the trailing flank 176 and the crest 178 is the same throughout the curved-line path of the second thread portion 172 and also in the straight-line portions (if any) of the second thread portion 172. Throughout the helical pattern, the cross-sectional shape remains the same. In the exemplary embodiment, the entire thread of the second thread portion 172, from the root 180 to the crest 178 follows a curved path within the helical pattern. Thus, the root 180 similarly follows a curved-line path in a generally helical pattern along the shank 162.

During operation, the second thread portion 172 provides prevailing torque or friction in the threaded joint between the fastener device 160 and the exemplary retaining device 34. Moreover, the continuously changing or variable pitch creates a predetermined amount of interference with the internal thread of the retaining device 34, and a constant running torque as the fastener device 160 is operated.

FIG. 10 is a cross-section of the exemplary fastener device 30 including the exemplary retaining device 34. It should be realized that the fastener device 30 and the retaining device 34 are an exemplary embodiment that is used to explain the operation of the adjusting assembly 20 and that other fastening devices or retaining devices described herein may also be used. As discussed above, in the exemplary embodiment, the fastener device 30 is coupled to the component 12 and the retaining device 34 is coupled to the component 14. As shown in FIG. 10, in the exemplary embodiment, the retaining device 34 also includes at least one tab 181 that enables the retaining device 34 to engage the component 14. In the exemplary embodiment, the tab 181 is formed unitarily with the retaining device 34. To couple the retaining device 34 to the component 14, the tab 181 is inserted into an opening 182 formed in the component 14 such that the retaining device 34 is snap fit into the opening 182 and thus coupled to the component 14.

To reposition the component 12 with respect to the component 14, the fastener device 30 is rotated in either a first direction 200 or an opposite direction 202 as discussed in FIGS. 1A and 1B. As the fastener device 30 is rotated in the first direction 200, the retaining device 34, which is coupled to the fastener device 34, moves axially along the shank 36 as represented by the arrow 204 in FIG. 10. In the exemplary embodiment, the retaining device 34 moves axially along the shank 36 until the retaining device 34 reaches the end of its travel, e.g. the proximal end 46 of the first thread 40. At this point, the retaining device 34 is not engaged with or coupled to either the first thread 40 or the reversing thread 50. More specifically, as discussed above, in the exemplary embodiment, the gap 60 is less than or equal to a thickness 62 of a single thread in the retaining device 34. The width of the gap 60 is sufficient to enable the retaining device 34 to disengage from the first thread 40 and to enable the retaining device 34 to “freewheel” or continuously rotate in the first direction 200 while the operator is rotating the fastener device 30 in the first direction 200. As discussed above, conventional fasteners experience over torque conditions and eventually break when rotated past the end of the thread travel. Whereas, the exemplary fastener device 30 is configured to allow an operator to rotate the fastener device 30 such that the retaining device 34 travels past its end of travel, e.g. past the end 46 of the first thread 40, without damaging either the fastener device 30 or the retaining device 34.

In one operational embodiment, when the fastener device 34 has exceeded past the end of the first thread 40, rotating the fastener device 34 in the second direction 202 causes the retaining device to be moved in a second axial direction 206. More specifically, the reversing thread 50 contacts the retaining device 34 and forces the retaining device 34 to move in a second axial direction 206. In the exemplary embodiment, when the fastener device 30 is rotated in the second direction 206, the reversing thread 50 applies a force to the retaining device 34 that is sufficient to enable the retaining device 34 to reengage the first thread 40.

Described herein is a linear adjustment assembly that may be used to reposition a movable component. The linear adjustment assembly, and all components included therein, is fabricated from a material that resists corrosion, such as plastic, for example. The linear adjustment assembly prevents an over-torque condition from occurring and thus prevents the linear adjustment assembly from being damaged during operation.

The linear adjustment assembly includes a fastener device that includes a first thread, a reversing thread, and a gap defined between the first thread and the reversing thread. The gap enables the fastener device to continuously rotate when the fastener device is operated in a first direction. The reversing thread drives the retaining device onto the first thread when the retaining device is rotated in an opposite direction. The fastener device also includes a concave spring that is formed unitarily with the fastener device. The spring exerts some pressure on the component to which the fastener device is coupled. This pressure enables the fastener device to remain coupled to the component, reduces axial movement of the fastener device with respect to the component, and also enables the retaining device to move freely in a radial direction with respect to the component.

The linear adjustment assembly also includes a retaining device that includes a least one friction ramp, or other device, formed unitarily with the retaining device threads. The friction ramp allows for the creation and control of prevailing torque between the fastener device and the retaining device. The prevailing torque enabled by the friction ramp also enables the linear adjustment assembly to compensate for vibration without self-adjusting and changing the position of the movable component.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. An adjusting device for repositioning a movable component relative to a stationary component, said adjusting device comprising:
a shank having a head at one end thereof and a distal tip at an opposite end thereof;
a first thread formed on the shank, the first thread disposed in a helical pattern along the shank, the first thread being configured to receive a threaded retaining device; and
a reversing thread formed on the shank, the reversing thread disposed in a helical pattern along the axial surface of the shank, the reversing thread helical pattern is formed in a direction that is opposite to the helical pattern of the first thread.

2. An adjusting device in accordance with claim 1 wherein the reversing thread is formed on the shank between the first thread and the head.

3. An adjusting device in accordance with claim 1 wherein the first thread includes a proximal end and a distal end, and the reversing thread includes a proximal and distal end, the first thread proximal end is separated from the reversing thread distal end by a longitudinal distance along the length of the shank, the longitudinal distance is less than a width of the retaining device.

4. An adjusting device in accordance with claim 1 wherein the first thread includes a proximal end and a distal end, and the reversing thread includes a proximal and distal end, the first thread proximal end is separated from the reversing thread distal end by a longitudinal distance along the length of the shank, the longitudinal distance is less than a width of a single thread in the retaining device.

5. An adjusting device in accordance with claim 1 wherein the reversing thread is configured to enable a retaining device to continuously rotate when the adjusting device is rotated in a first direction and to enable the retaining device to engage the first thread when the adjusting device is rotated in an opposite second direction.

6. An adjusting device in accordance with claim 1 wherein the first thread has a first helical pitch and the reversing thread has a second helical pitch that is different than the first helical pitch.

7. An adjusting device in accordance with claim 1 wherein the first thread has a first helical pitch and the reversing thread has a second helical pitch that is different than the first helical pitch, the first thread configured to receive a retaining device that has a helical pitch that is similar to the first helical pitch.

8. An adjusting device in accordance with claim 1 further comprising a latch mechanism formed unitarily with the adjusting device, the latch mechanism configured to enable the adjusting device to be coupled to at least one of the movable component and the stationary component.

9. An adjusting device in accordance with claim 1 wherein the adjusting device comprises a plastic material.

10. An adjusting device in accordance with claim 1 further comprising a convex spring formed unitarily with the head, the spring is configured to retain the fastener head against at least one of the stationary component and the movable component.

11. An adjusting device in accordance with claim 1 wherein at least a portion of the first thread follows a curved-line path.

12. An adjustment assembly for repositioning a component, said adjustment assembly comprising:
a fastener device comprising
a shank having a head at one end thereof and a distal tip at an opposite end thereof;
a first thread formed on the shank, the first thread disposed in a helical pattern along the shank; and
a reversing thread formed on the shank, the reversing thread disposed in a helical pattern along the axial surface of the shank, the reversing thread helical pattern is formed in a direction that is opposite to the helical pattern of the first thread; and
a retaining device coupled to the fastener device.

13. An adjustment assembly in accordance with claim 12 wherein the retaining device comprises:
a thread disposed in a helical pattern along an interior surface of the retaining device, the retaining device thread having a helical pattern that is substantially similar to the first thread helical pattern; and
at least one of a friction ramp and a plurality of protrusions formed unitarily with the retaining device thread and configured to create and control of prevailing torque between the fastener device and the retaining device.

14. An adjustment assembly in accordance with claim 12 wherein the reversing thread is formed on the shank between the first thread and the head.

15. An adjustment assembly in accordance with claim 12 wherein the first thread includes a proximal end and a distal end, and the reversing thread includes a proximal and distal end, the first thread proximal end is separated from the reversing thread distal end by a longitudinal distance along the length of the shank, the longitudinal distance is less than a width of the retaining device.

16. An adjustment assembly in accordance with claim 12 wherein the first thread includes a proximal end and a distal end, and the reversing thread includes a proximal and distal end, the first thread proximal end is separated from the reversing thread distal end by a longitudinal distance along the length of the shank, the longitudinal distance is less than a width of a single thread in the retaining device.

17. An adjustment assembly in accordance with claim 12 wherein the reversing thread is configured to enable the retaining device to continuously rotate when the fastener device is rotated in a first direction and to enable the retaining device to engage the first thread when the fastener device is rotated in an opposite second direction.

18. An adjustment assembly in accordance with claim 12 wherein the first thread has a first helical pitch and the reversing thread has a second helical pitch that is different than the first helical pitch.

19. An adjustment assembly in accordance with claim 12 further comprising a latch mechanism formed unitarily with the fastener device, the latch mechanism configured to enable the fastener device to be coupled to at least one of the movable component and the stationary component.

20. An adjustment assembly in accordance with claim 12 wherein the fastener device and the retaining device are comprise a plastic material.

21. An adjustment assembly in accordance with claim 12 further comprising a convex spring formed unitarily with the fastener head, the spring is configured to retain the fastener head against at least one of the stationary component and the movable component.

22. An adjustment assembly in accordance with claim 12 wherein at least a portion of the first thread follows a curved-line path.
